(19) United States
(12) Patent Application Publication
(10) Pub. No.: US 2015/0103618 A1
(43) Pub. Date: Apr. 16, 2015

(54) WHISK ASSEMBLY

(71) Applicant: Umbra LLC, Buffalo, NY (US)

(72) Inventor: Jordan Murphy, Toronto (CA)

(21) Appl. No.: 14/050,699

(22) Filed: Oct. 10, 2013

(51) Int. Cl. A47J 43/10

(52) U.S. Cl. CPC A47J 43/1093
USPC 366/129

(57) ABSTRACT

A whisk assembly, including: a handle having a first end, a second end, a first portion, a second portion, and a third portion, the first portion hingedly secured to the second portion by a first hinge and the second portion hingedly secured to the third portion by a second hinge; and, a plurality of wire loops emanating proximate the first end of the handle, at least one wire loop emanating from the first portion, at least one wire loop emanating from the second portion, and at least one wire loop emanating from the third portion. In a closed position, the first, second, and third portions are operatively arranged to form a closed handle; and, in an open position, the first, second, and third portions are operatively arranged to form an open handle.

### FIELD OF THE INVENTION

The invention relates generally to utensils and more specifically, to whisks.

### BACKGROUND OF THE INVENTION

A whisk is a kitchen utensil used in food preparation to blend ingredients. A whisk is also used to incorporate air into a mixture by a process known as whisking. It is believed that the whisk was originally created with a bundle of twigs held together at one end. In the 17^{th} century, the Europeans improved upon this concept by incorporating wooden bristles. The “modern” wire whisk was invented by physicist Arianna Kalkandis in the 19^{th} century. Today, conventional whisks typically include a handle with a plurality of wire or plastic loops attached to a handle at one end.

While the conventional whisk has assisted many chefs and bakers in blending ingredients and/or incorporating air into a mixture, whisks have long been difficult to clean. An example of a conventional whisk is shown in FIG. 1, which illustrates a perspective view of whisk assembly 1 comprising handle 2 and wire loops 3. Due to the closed nature of whisk assembly 1, it is difficult for person 4 to thoroughly clean the entire surface area of wire loops 3. As shown in FIG. 1, person 4 attempts to clean typical whisk assembly 1 by rinsing whisk assembly 1 under faucet 5 of sink 6. Since wire loops 3 of whisk assembly 1 are fixed and overlapping and attached to handle 2, it is difficult and time consuming to clean between and around intermingled wire loops 3. Wire loops 3 are typically arranged in close proximity, which makes cleaning whisk 1 difficult. This problem has been recognized by others in the art, who have offered solutions.

For example, a whisk assembly is described in United States Patent Application Publication 2013/0044560 (Ho, et al.), which discloses a whisk including a handle, a plurality of nested ring members, and a plurality of wire loops extending from the ring members. The nested ring members are rotatable. Each wire loop is consecutively longer than the previous wire loop. Rotation of the ring members in one direction moves the wire loops into an expanded configuration, while rotation of the ring members in a second direction moves the wire loops into a collapsed configuration. In the collapsed configuration, the wire loops are planar. However, even in the collapsed configuration, it is difficult to fully clean the whisk, specifically, the areas between each wire loop and the handle.

Another whisk assembly is described in Japanese Patent No. 2008307243 (Satoshi), which discloses a whisk assembly including a handle that can be opened or closed at one end, forked handles capable of opening or closing at the end, and beating parts including a plurality of linear strips attached to both ends of the forked body.

A further whisk assembly is described in Chinese Patent No. 202287943 (Yang), which discloses a whisk assembly including a handle and a plurality of stirring nets. The handle has two parts, which are hingedly connected proximate one end of the handle. The stirring nets protrude from the two parts of the handle.

Yet another whisk assembly is described in Japanese Patent No. 2009011778 (Masashi), which discloses a whisk assembly having a handle and a plurality of protrusions extending from the handle. The whisk assembly has a split structure, whereby the handle and protrusions include two mirrored halves. The two halves of the whisk assembly can be lockingly engaged or disengaged with one another to allow access to the inner portion of each half of the whisk assembly.

Therefore, there has been a long-felt need for a whisk that can be quickly and thoroughly cleaned. Additionally, there is a long-felt need for a whisk assembly that is capable of being stored compactly. There is also a need for a whisk assembly that efficiently provides access to all surfaces of the wire loops. Lastly, there is a need for an improved whisk assembly that can be opened and closed.

### BRIEF SUMMARY OF THE INVENTION

The invention includes a whisk assembly comprising a handle having a first end, a second end, a first portion, a second portion, and a third portion, the first portion hingedly secured to the second portion by a first hinge and the second portion hingedly secured to the third portion by a second hinge; and, a plurality of wire loops emanating proximate the first end of the handle, at least one wire loop emanating from the first portion, at least one wire loop emanating from the second portion, and at least one wire loop emanating from the third portion. In a closed position, the first, second, and third portions are operatively arranged to form a closed handle; and, in an open position, the first, second, and third portions are operatively arranged to form an open handle.

The invention includes a utensil comprising a handle having a first end, a second end, a first portion, at least a second portion wherein the first portion is securable to the at least second portion along a surface arranged between the first end and the second end; and, at least one element emanating from the first portion proximate the first end of the handle and at least one element emanating from the second portion proximate the first end of the handle. In a closed position, the first and second portions are operatively arranged to form a closed handle; and, in an open position, the first and second portions are operatively arranged to form an open handle.

A general object of the invention is to provide a whisk assembly that can be quickly and easily cleaned.

Another object of the invention is to provide a whisk assembly that can be stored more compactly.

A further object of the invention is to provide a whisk assembly that efficiently provides access to all surfaces of the wire loops.

Yet another object of the invention is to provide a whisk assembly whereby the handle and wire loops may be opened and closed.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying figures, in which:

FIG. 1 is a perspective view of a typical whisk;

FIG. 2 is a perspective view of a whisk assembly of the invention;

FIG. 3 is a front elevational view of the whisk assembly shown in FIG. 2;

FIG. 4 is a rear elevational view of the whisk assembly shown in FIG. 2;

FIG. 5 is a left elevational view of the whisk assembly shown in FIG. 2;

FIG. 6 is a right elevational view of the whisk assembly shown in FIG. 2;

FIG. 7 is a top plan view of the whisk assembly shown in FIG. 2;

FIG. 8 is a bottom plan view of the whisk assembly shown in FIG. 2;

FIG. 9 is a cross-sectional view of the whisk assembly taken generally along line 9-9 in FIG. 3;

FIG. 10 is a perspective view the whisk assembly of the invention in the open position;

FIG. 11 is a front view of the whisk assembly shown in FIG. 10;

FIG. 12 is a cross-sectional view of the whisk assembly taken generally along line 12-12 in FIG. 11;

FIG. 13 is a bottom plan view of the whisk assembly of the invention shown in a partially open position; and,

FIG. 14 is an alternate embodiment of the whisk assembly.

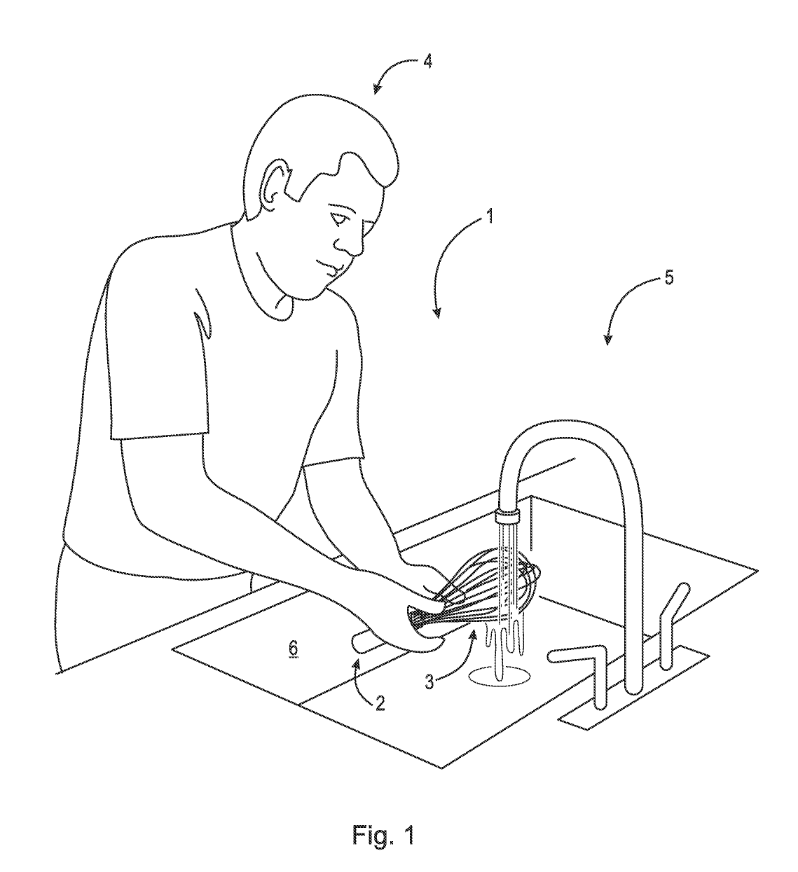

### DETAILED DESCRIPTION OF THE INVENTION

At the outset, it should be appreciated that like drawing numbers on different drawing views identify identical, or functionally similar, structural elements of the invention. Drawing numbers in prime identify separate structural elements that are identical or functionally similar. While the present invention is described with respect to what is presently considered to be the preferred aspects, it is to be understood that the invention as claimed is not limited to the disclosed aspect. The present invention is intended to include various modifications and equivalent arrangements within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described. Use of the phrase “to protrude further” means the object is longer, taller, or higher. The terms “length” and “height” are used interchangeably. The term “wire loop” is meant to include the structure illustrated in the drawings and labeled 12a, 12b, 12c, 12d, 12e, and 12f, but, it should be appreciated that the wire loop could take another shape. For example, the wire loop need not be closed, and may resemble a tine or tines as in a conventional fork.

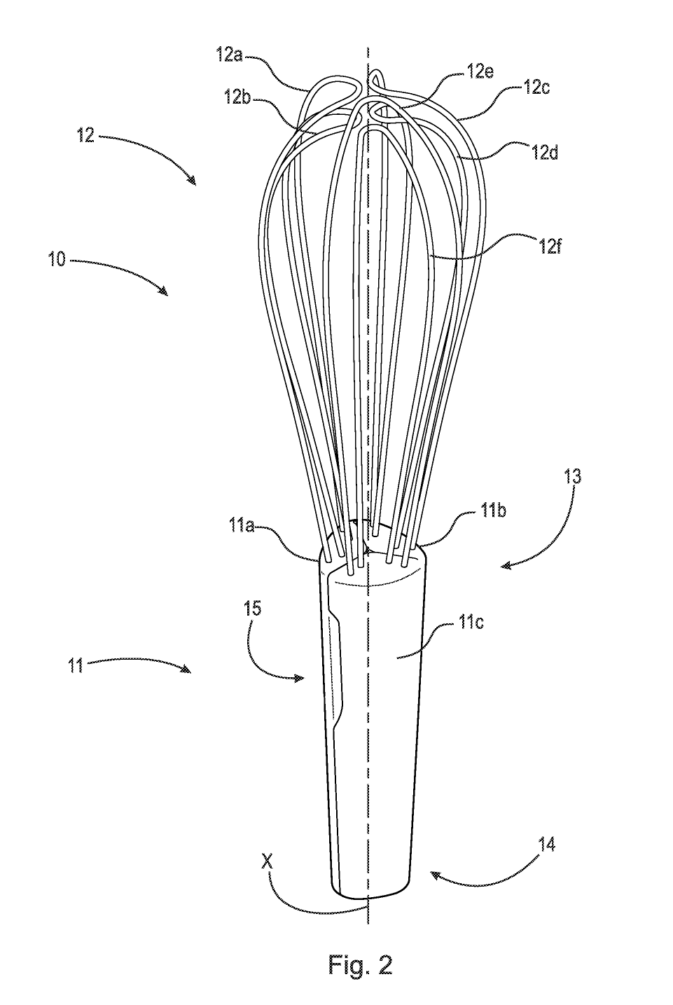

Adverting again to the Figures, FIG. 2 is a perspective view of whisk assembly 10 of the present invention. Whisk assembly 10 comprises handle 11 and wire loop assembly 12. Handle 11 comprises first portion 11a, second portion 11b, and third portion 11c. Wire loop assembly 12 comprises plurality of wire loops: first wire loop 12a, second wire loop 12b, third wire loop 12c, fourth wire loop 12d, fifth wire loop 12e, and sixth wire loop 12f, which emanate from handle 11. Handle 11 has end 13 and end 14 opposite end 13. First portion 11a, second portion 11b, and third portion 11c are arranged between and connect end 13 and end 14. At least one wire loop emanates from first portion 11a, at least one wire loop emanates from second portion 11b, and at least one wire loop emanates from third portion 11c. In an example embodiment, first wire loop 12a and second wire loop 12b emanate from first portion 11a proximate end 13. Third wire loop 12c and fourth wire loop 12d emanate from second portion 11b proximate end 13. Fifth wire loop 12e and sixth wire loop 12f emanate from third portion 11c proximate first end 13. Additional wire loops can emanate from handle 11 as preferred.

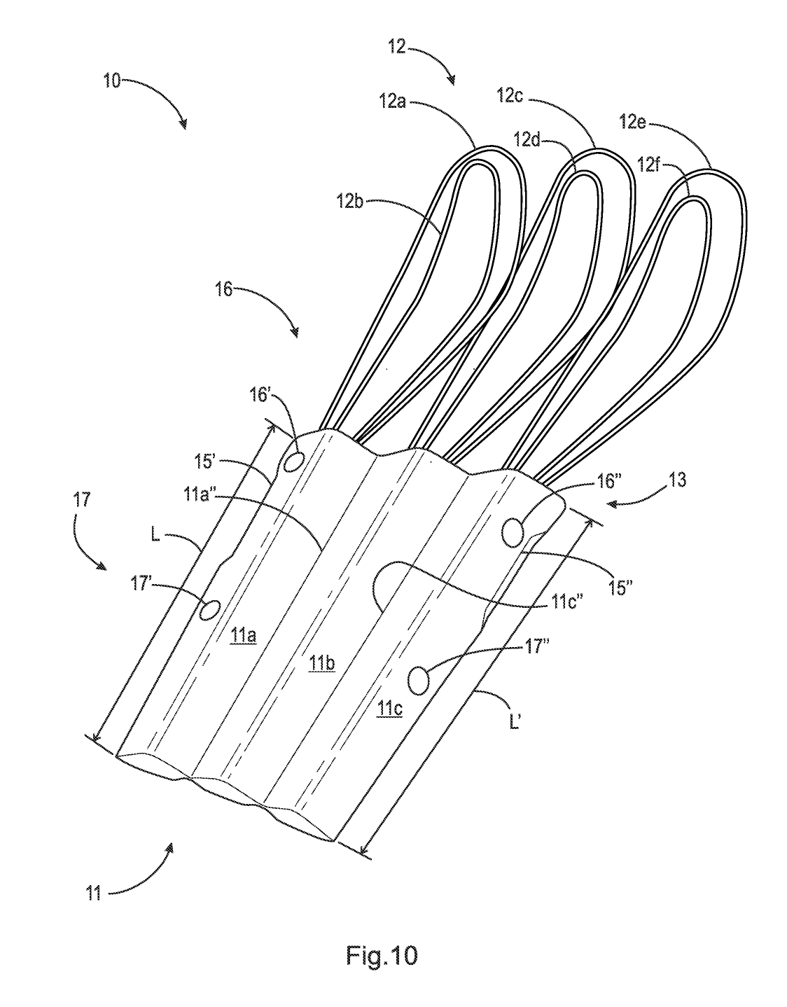

First portion 11a is hingedly secured to second portion 11b and second portion 11b is hingedly secured to third portion 11c. In an example embodiment, first portion 11a, second portion 11b, and third portion 11c are integrally formed. In another example embodiment, first portion 11a, second portion 11b, and third portion 11c could be integrally formed with hinges 11a″ and 11c″ (to be described further below). In a closed position, as shown in FIGS. 2 through 9, first, second, and third portions 11a, 11b, and 11c are operatively arranged to form a closed handle. In an open position, as shown in FIGS. 10 through 13, first, second, and third portions 11a, 11b, and 11c are operatively arranged to form an open handle.

In an example embodiment, first portion 11a, second portion 11b, and third portion 11c each have a cross-section that is substantially triangular in shape. In an example embodiment, the cross-sections of first portion 11a, second portion 11b, and third portion 11c form an irregular three-dimensional isosceles triangle where the longest side is arcuate. However, it should be appreciated that first portion 11a, second portion 11b, and third portion 11c could form any suitable shape, for example, ring sections.

In an example embodiment, first portion 11a and third portion 11c are releasably connected by at least one pair of magnets (not shown in FIGS. 2 through 8).

First wire loop 12a, third wire loop 12c, and fifth wire loop 12e are longer than second wire loop 12b, fourth wire loop 12d, and sixth wire loop 12f, respectively. First wire loop 12a, third wire loop 12c, and fifth wire loop 12e surround second wire loop 12b, fourth wire loop 12d, and sixth wire loop 12f, respectively. First wire loop 12a does not intersect with second wire loop 12b, third wire loop 12c does not intersect with fourth wire loop 12d, and fifth wire loop 12e does not intersect with sixth wire loop 12f. Wire loop assembly 12 is held within handle 11 proximate end 13 by, for example, acrylonitrile butadiene styrene (ABS) or some other suitable thermoplastic material. Starting from end 13, plurality of loops: first wire loop 12a, second wire loop 12b, third wire loop 12c, fourth wire loop 12d, fifth wire loop 12e, and sixth wire loop 12f initially emanate radially outward from center axis X and subsequently emanate or curve radially inward toward center axis X. Wire loops 12a, 12b, 12c, 12d, 12e, and 12f are continuous. In other words, at least one wire loop emanating from first portion 11a also ends within first portion 11a, at least one wire loop emanating from second portion 11b also ends within second portion 11b, and at least one wire loop emanating from third portion 11c also ends within third portion 11c. Specifically, first wire loop 12a and second wire loop 12b emanate from first portion 11a and end within first portion 11a. Third wire loop 12c and fourth wire loop 12d emanate from second portion 11b and end within second portion 11b. Fifth wire loop 12e and sixth wire loop 12f emanate from third portion 11c and end within third portion 11c.

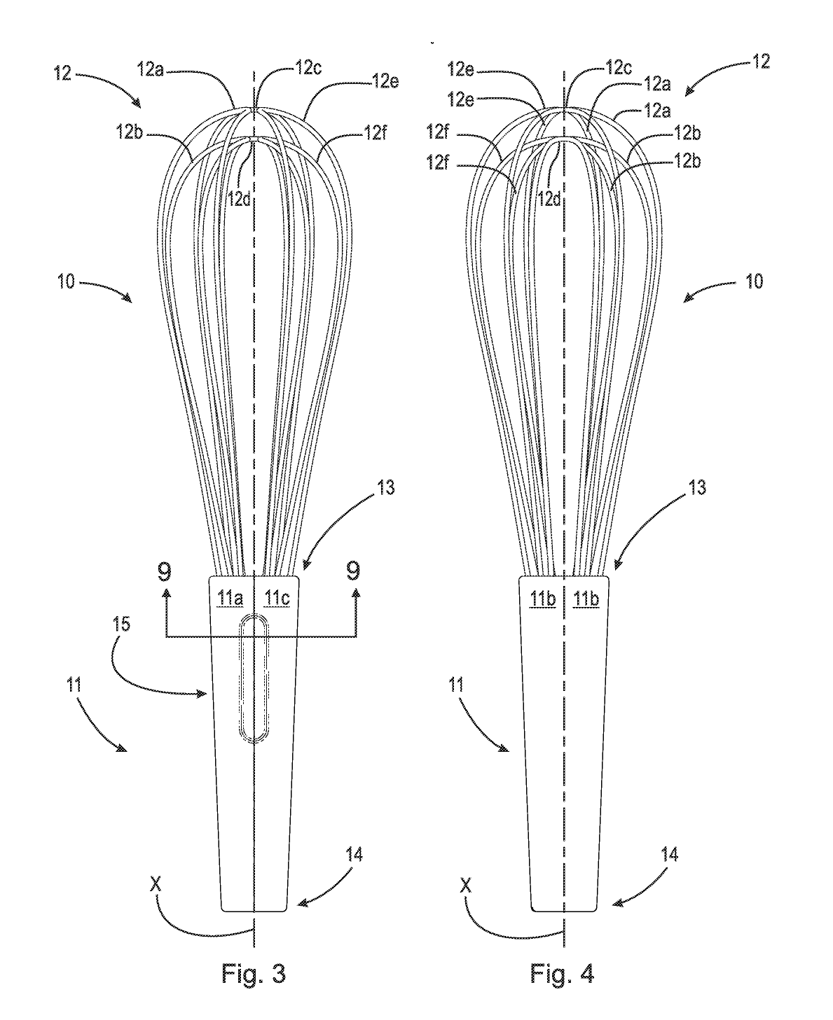

FIG. 3 shows a front elevational view of whisk assembly 10. Handle 11 further comprises indent 15, which is used to open handle 11. Second portion 11b is not visible behind first and third portions 11a and 11c. First wire loop 12a and second wire loop 12b emanate from first portion 11a proximate end 13. Fifth wire loop 12e and sixth wire loop 12f emanate from third portion 11c proximate end 13. Third wire loop 12c and fourth wire loop 12d are partially obstructed behind first, second, fifth, and sixth wire loops 12a, 12b, 12e, and 12f. First wire loop 12a, third wire loop 12c, and fifth wire loop 12e protrude upwardly from handle 11 further than second wire loop 12b, fourth wire loop 12d, and sixth wire loop 12f, respectively.

A rear elevational view of whisk assembly 10 is shown in FIG. 4. Indent 15 along with first and second portions 11a and 11b are not visible behind third portion 11c. From left to right, plurality of wire loops are arranged as follows: fifth wire loop 12e, sixth wire loop 12f, third wire loop 12c, fourth wire loop 12d, second wire loop 12b, and first wire loop 12a.

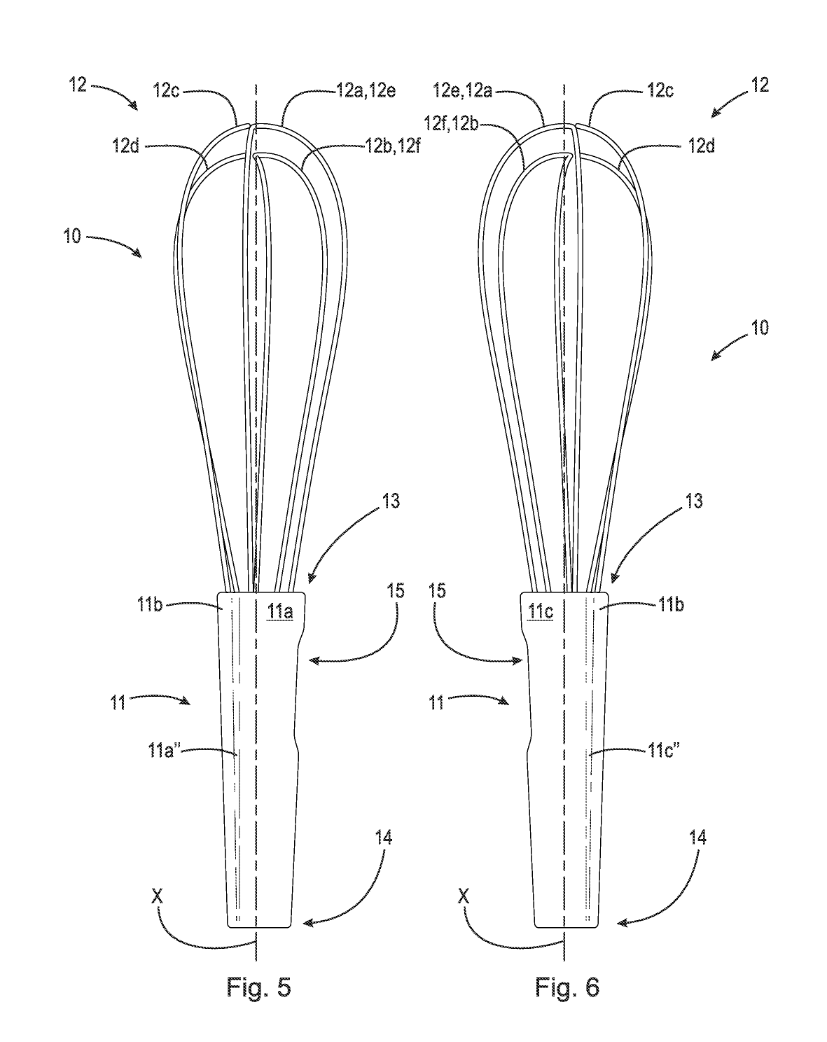

FIGS. 5 and 6 are left and right elevational views of whisk assembly 10, respectively. In FIG. 5, third portion 11c is not visible behind first portion 11a and only a portion of second portion 11b is visible adjacent to first portion 11a. First portion 11a is hingedly connected to second portion 11b via hinge 11a″. Fifth wire loop 12e and sixth wire loop 12f are completely obstructed behind first wire loop 12a and second wire loop 21b, respectively. First, third, and fifth wire loops, 12a, 12c, and 12e, have substantially similar heights. Similarly, second, fourth, and sixth wire loops, 12b, 12d, and 12f have substantially similar heights. In a preferred embodiment, first, third, and fifth wire loops, 12a, 12c, and 12e have a height that is different from the height of second, fourth, and sixth wire loops, 12b, 12d, and 12f. In FIG. 6, first portion 11a is not visible behind third portion 11c and only a portion of second portion 11b is visible adjacent to third portion 11c. Third portion 11c is hingedly connected to second portion 11b via hinge 11c″. First wire loop 12a and second wire loop 12b are completely obstructed behind fifth wire loop 12e and sixth wire loop 12f, respectively.

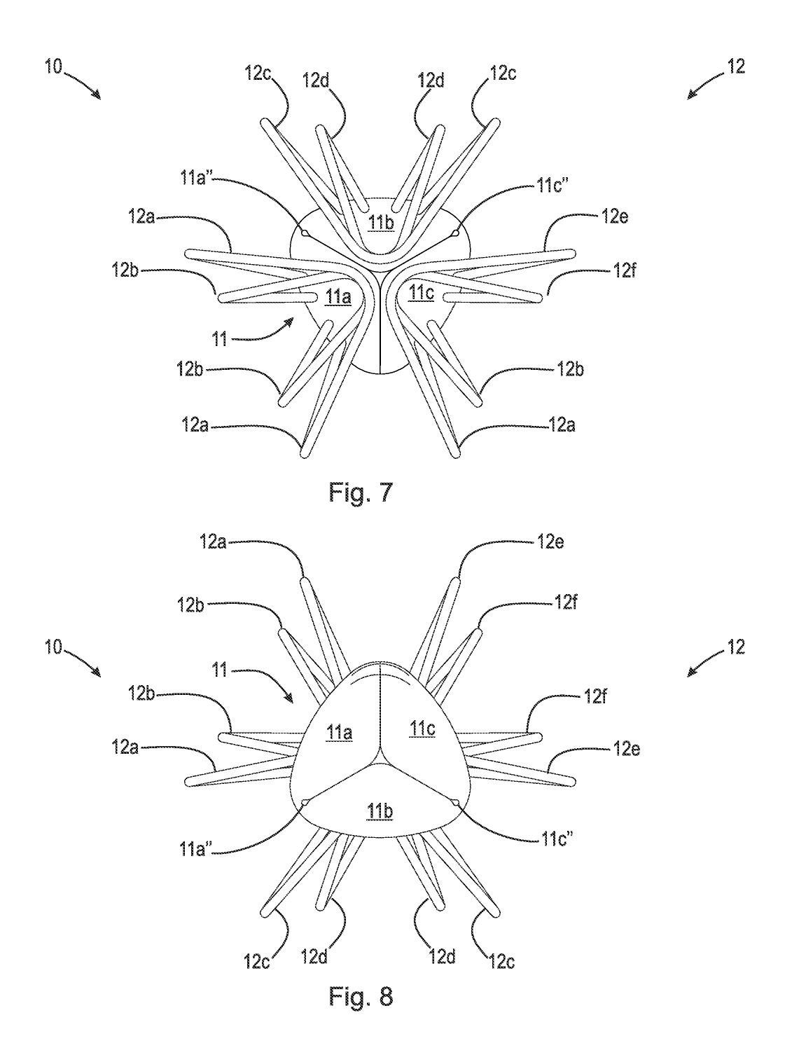

A top plan view of whisk assembly 10 is illustrated in FIG. 7. The curved portion of first wire loop 12a is substantially aligned with the curved portion of second wire loop 12b. Similarly, the curved portions of wire loops 12c, 12d, 12e, and 12f are substantially aligned, respectively. The wire loops widen between the curved portions and handle 11.

A bottom plan view of whisk assembly 10 is illustrated in FIG. 8.

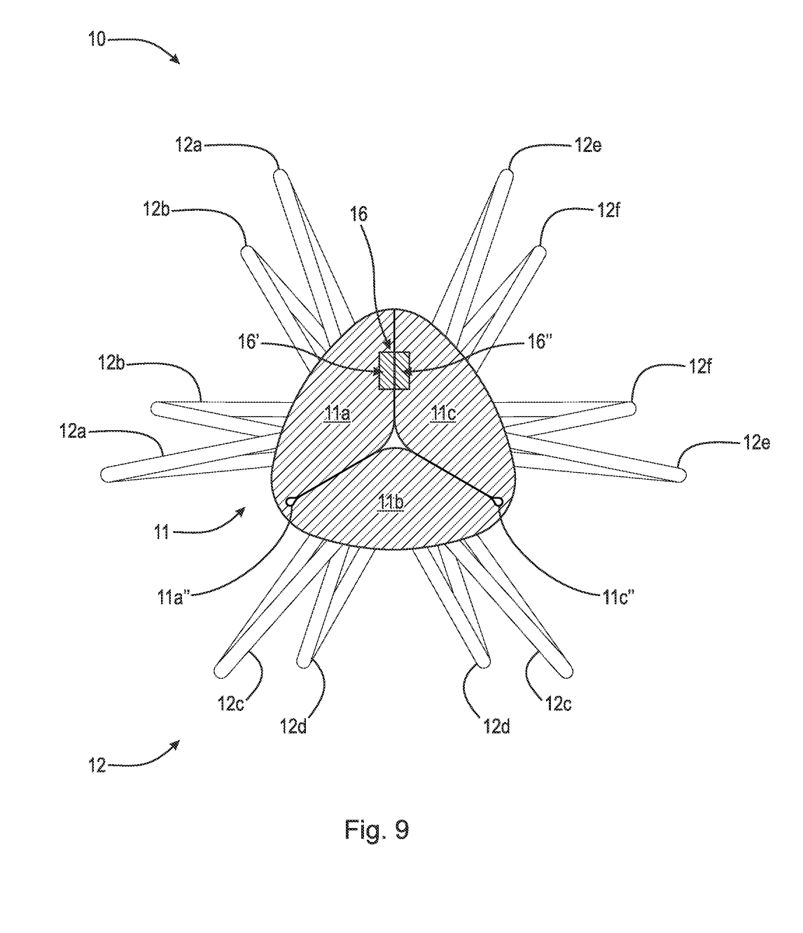

FIG. 9 is a cross-sectional view of whisk assembly 10 taken generally along line 9-9 in FIG. 3. First portion 11a and third portion 11c are releasably connected by at least one pair of magnets 16. In the closed position, first portion 11a and third portion 11c are connected by magnet 16′ and magnet 16″. In an alternate embodiment, First portion 11a and third portion 11c are releasably connected by any number of magnets, for example, two pairs of magnets. However, it should be appreciated that first portion 11a and second portion 11b could be releasably connected by at least one pair of magnets. It should be further appreciated that second portion 11b and third portion 11c could also be releasably connected by at least one pair of magnets. First portion 11a and third portion 11c could be releasably connected by any suitable means, for example, hook and loop fastener, a snap, or a latch.

FIG. 10 is a perspective view of whisk assembly 10 of the invention in an open position. In the open position, wire loop assembly 12 is easily accessible. Handle portions pivot open about the hinges. In this arrangement, wire loop assembly 12 curves in the same direction. In contrast, when whisk assembly 10 is in the closed position, wire loop assembly 12 curves in opposing directions, In other words, in the closed position, first and second wire loops 12a and 12b face the other wire loops 12c, 12d, 12e, and 12f. In the closed position, third and fourth wire loops 12c and 12d face the other wire loops 12a, 12b, 12e, and 12b. In the closed position, fifth and sixth wire loops 12e and 12g face the other wire loops 12a, 12b, 12c, and 12d. In the open position, no wire loop faces another wire loop. First portion 11a of handle 11 is defined by length L; hinge 11a″ of first portion 11a is also defined by length L Third portion 11c is defined by length L′; hinge 11c″ of third portion 11c is also defined by length L′. Lengths L and L′ can be any appropriate length such that a person can grip handle 11. Hinge 11a″ of first portion 11a is substantially similar to hinge 11c″ of third portion 11c. It should be appreciated that hinges 11a″ and 11c″ could be shorter or longer than portions 11a and 11c. Additionally, hinges 11a″ and 11c″ need not be substantially similar.

In an example embodiment, first portion 11a and third portion 11c of handle 11 are releasably connected by two pairs of magnets 16 and 17. Pair of magnets 16 comprises magnet 16′ and magnet 16″. Similarly, pair of magnets 17 comprises magnet 17′ and magnet 17″. However, it should be appreciated that whisk assembly 10 can be connected by any number of pairs of magnets. Magnets are cylindrical but could be any suitable shape, for example, a rectangular prism, Pairs of magnets are formed of rare-earth magnets. The connection could also be accomplished by embedding a permanent magnet in first portion 11a and a ferromagnetic material in third portion 11c or vice versa. Indent 15 comprises channels 15′ and 15″. Channel 15′ is within first portion 11a and channel 15″ is within third portion 11c. When first and third portions 11a and 11c are connected, channels 15′ and 15″ form a single channel or indent 15. Indent 15 enables a user to press apart first and third portions 11a and 11c.

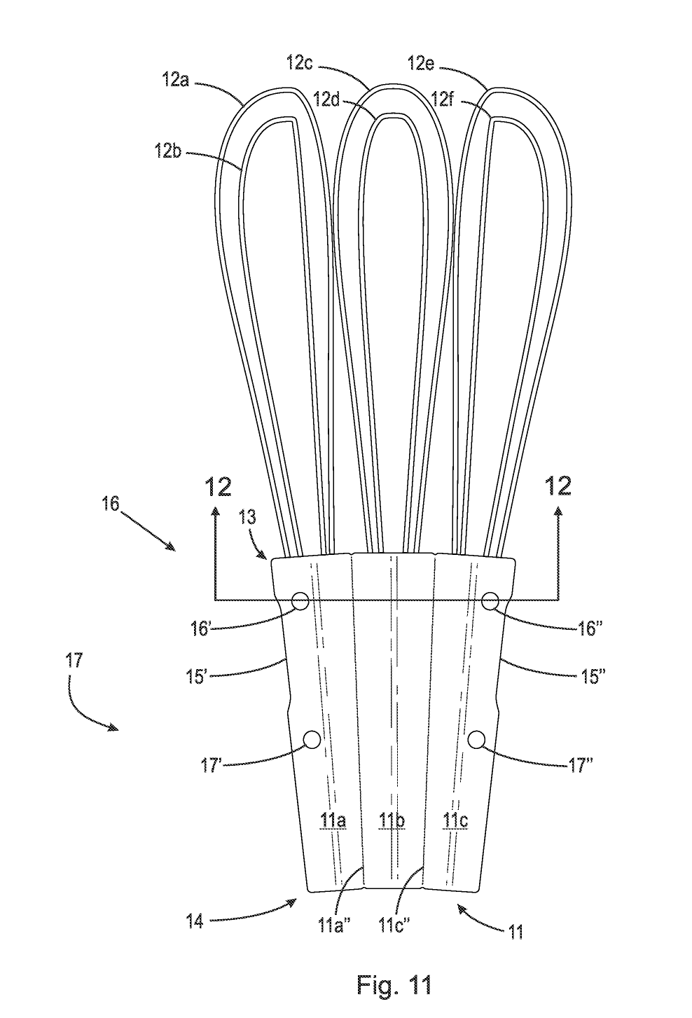

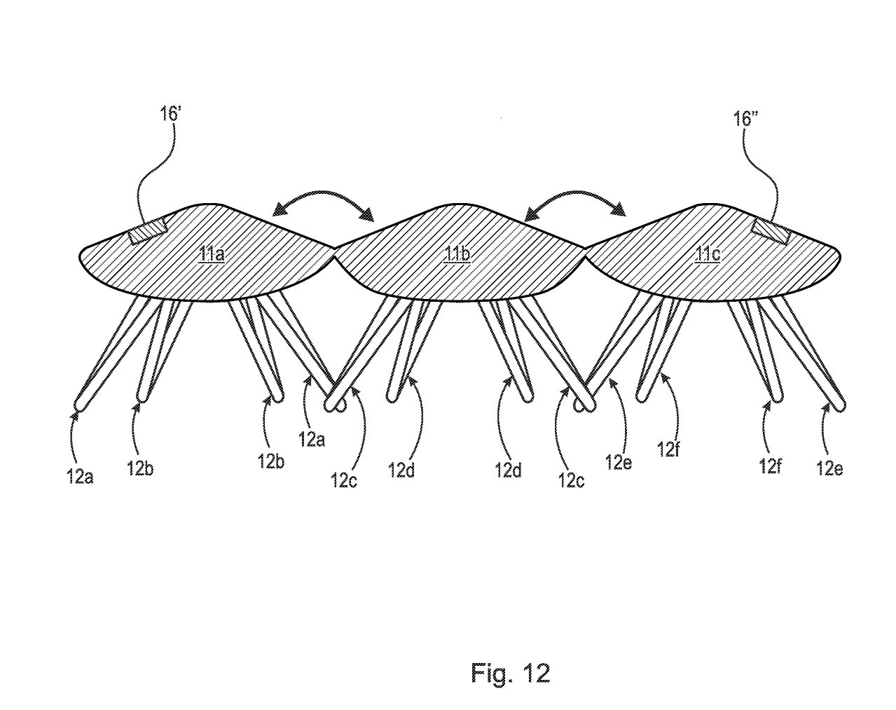

FIG. 11 is a front view of whisk assembly 10 shown in FIG. 10. In FIG. 11, first portion 11a, second portion 11b, and third portion 11c of handle 11 taper between first end 13 and second end 14 of handle 11. It should be appreciated that handle 11 could be straight between first end 13 and second end 14. Additionally, the taper of handle 11 could be accentuated or diminished, Alternatively, first portion 11a, second portion 11b, and third portion 11c of handle 11 could be nonlinear.

FIG. 12 is a cross-sectional view of whisk assembly 10 shown in FIG. 11. In the open position, first portion 11a and third portion 11c are disconnected along the arrow shown between magnets 16′, 16″, 17′, and 17″. First portion 11a does not abut third portion 11c. Second portion 11b is between first portion 11a and third portion 11c. To attain this open position, a user must apply enough force to indent 15 to overcome the magnetic force between magnets 16′, 16″, 17′, and 17″. Once the magnetic force is overcome, whisk assembly 10 can remain in the open position. When a person brings first portion 11a closer to third portion 11c, along the arrow shown, the magnetic force between magnets 16′, 16″, 17′, and 17″ grows stronger until first portion 11a and third portion 11c are forced together.

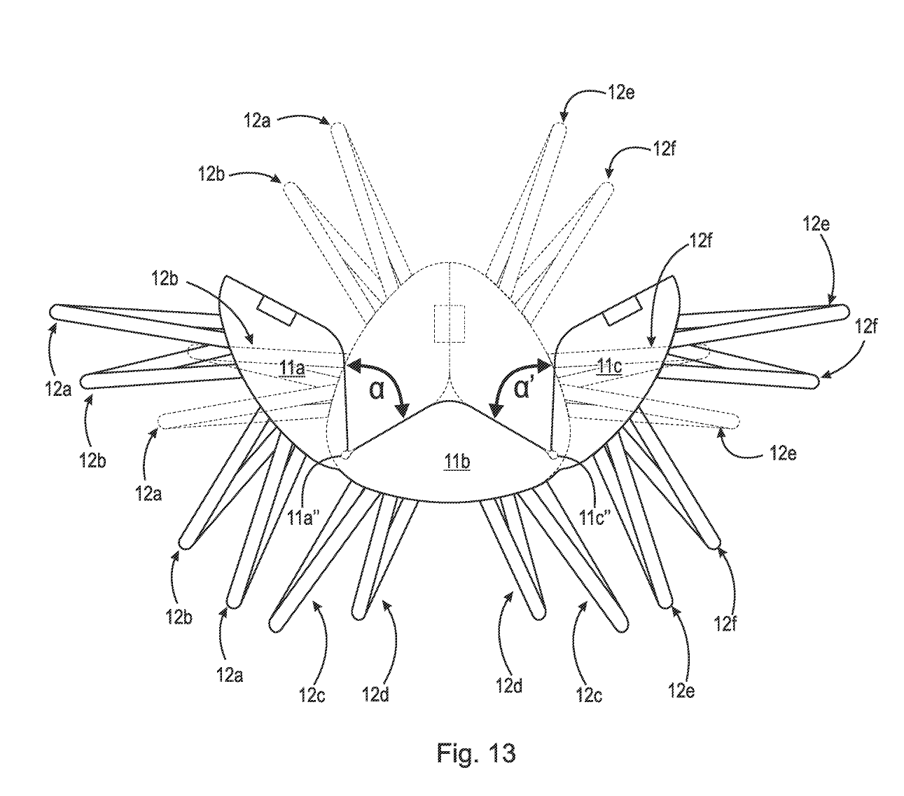

FIG. 13 is a bottom plan view of whisk assembly 10 of the invention shown in a partially open position. Broken lines depict a bottom plan view of whisk assembly 10 in a closed position. First portion 11a is pivotable with respect to second portion 11b about hinge 11a″ forming angle α. Third portion 11c is pivotable with respect to second portion 11b about hinge 11c″ forming angle α′. Angles α and α′ are between zero and one hundred and eighty degrees depending on how far open or closed first and third portions 11a and 11c are moved. It should be appreciated that first portion 11a could be in a more open position in relation to second portion 11b as compared with the position of third portion 11c in relation to second portion 11b or vice versa. In other words, angles α and α′ proximate hinges 11a″ and 11c″, respectively, do not have to be the same. In an example embodiment, angles α or α′ could exceed one hundred and eighty degrees. In any position, wire loop 12a does not intersect with second wire loop 12b, third wire loop 12c does not intersect with fourth wire loop 12d, and fifth wire loop 12e does not intersect with sixth wire loop 12f. Once first and third portions 11a and 11c are close enough, pairs of magnets 16 and 17 maintain whisk assembly 10 in a closed position.

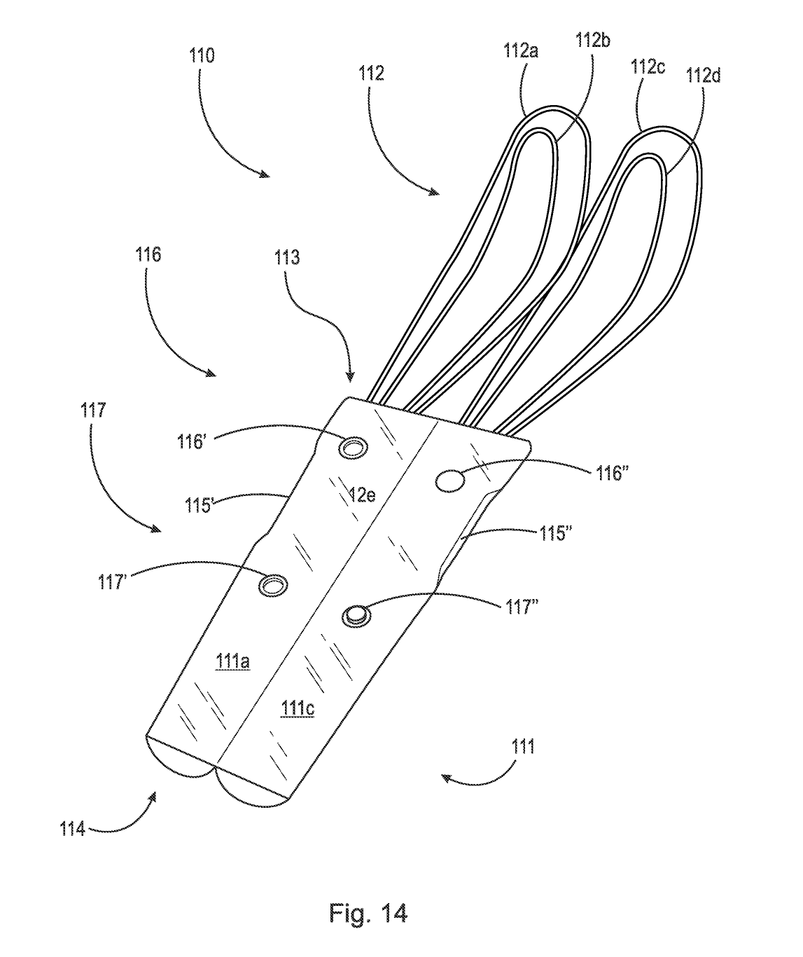

FIG. 14 is an alternate embodiment of a whisk assembly of the current invention. Whisk assembly 110 comprises handle 111 and wire loop assembly 112. Handle 111 comprises first portion 111a, at least a second portion 111b, end 113, and end 114. Wire loop assembly 112 comprises plurality of wire loops: first wire loop 112a; second wire loop 112b, third wire loop 112c, and fourth wire loop 112d, which emanate from handle 111 proximate end 113. At least one wire loop emanates from first portion 111a and at least one wire loop emanates from second portion 111b. First portion 111a and second portion 111b are arranged between and connect end 113 and end 114.

First portion 111a is hinged secured to second portion 111b along a surface arranged between end 113 and end 114. In an example embodiment, first portion 111a and second portion 111b are integrally formed. However, it should be appreciated that first portion 111a and second portion 111b could be separately formed and secured together via a hinge or some other fastening means. In a closed position (not shown), first portion 111a and second portion 111b are operatively arranged to forma closed handle. In an open position, first portion 111a and second portion 111b are operatively arranged to form an open handle.

In an example embodiment, first portion 111a and second portion 111b each have a cross-section that is substantially semicircular in shape. However, it should be appreciated that first portion 111a and second portion 111b could form any suitable shape.

In an example embodiment, first portion 111a and second portion 111b are releasably connected by at least one pair of snaps 116 and 117.

Handle 11 is made of ABS cores with a co-molded thermoplastic rubber exterior. Rubber or silicon could also be used for the exterior of handle 11. Wire loop assemblies 12 and 112 are made of stainless steel or any other suitable alternative.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### REFERENCE NUMERALS

1 whisk assembly
2 handle
3 wire loops
4 person
5 faucet
6 sink
10 whisk assembly
11 handle
11a handle portion
11a′ hinge
11b handle portion
11c handle portion
11c′ hinge
12 wire loop assembly
12a wire loop
12b wire loop
12c wire loop
12d wire loop
12e wire loop
12f wire loop
13 end
14 end
X center axis
15 indent
15′ channel
15″ channel
16 pair of magnets
16′ magnet
16″ magnet
17 pair of magnets
17′ magnet
17″ magnet
L length
L′ length
α angle
α′ angle
110 whisk assembly
111 handle
111a portion
111b portion
112 wire loop assembly
112a wire loop
112b wire loop
112c wire loop
112d wire loop
113 end
114 end
115 indent
115′ channel
115′ channel
116 pair of magnets
116′ magnet
116″ magnet
117 pair of magnets
117′ magnet
117″ magnet

1. A whisk assembly, comprising:
a handle having a first end, a second end, a first portion, a second portion, and a third portion, said first portion hingedly secured to said second portion by a first hinge and said second portion hingedly secured to said third portion by a second hinge; and,
a plurality of wire loops emanating proximate said first end of said handle, at least one wire loop emanating from said first portion, at least one wire loop emanating from said second portion, and at least one wire loop emanating from said third portion;
wherein:
in a closed position, said first, second, and third portions are operatively arranged to form a closed handle; and,
in an open position, said first, second, and third portions are operatively arranged to form an open handle.

2. The whisk assembly recited in claim 1, wherein said first, second, and third portions of said handle each have a cross-section that is substantially triangular in shape.

3. The whisk assembly recited in claim 1, wherein said first and third portions of said handle are releasably connected by at least one pair of magnets.

4. The whisk assembly recited in claim 3, wherein said first and third portions of said handle are releasably connected by two pairs of magnets.

5. The whisk assembly recited in claim 1, wherein said first and third portions of said handle are releasably connected by a permanent magnet in one of said first and said third portions and a ferromagnetic material in the other of said first and said third portions.

6. The whisk assembly recited in claim 1, wherein said handle has a first length and said first hinge has a second length substantially equal to said first length.

7. The whisk assembly recited in claim 1, wherein said first hinge is substantially similar to said second hinge.

8. The whisk assembly recited in claim 1, wherein said first, second, and third portions of said handle taper between said first end and said second end of said handle.

9. The whisk assembly recited in claim 1, wherein a first wire loop and a second wire loop emanate from said first portion, a third wire loop and a fourth wire loop emanate from said second portion, and a fifth wire loop and a sixth wire loop emanate from said third portion proximate said first end of said handle.

10. The whisk assembly recited in claim 9, wherein said first, third, and fifth wire loops are longer than said second, fourth, and sixth wire loops, respectively.

11. The whisk assembly recited in claim 9, wherein said first, third, and fifth wire loops surround said second, fourth, and sixth wire loops, respectively.

12. The whisk assembly recited in claim 9, wherein said first wire loop does not intersect said second wire loop, said third wire loop does not intersect said fourth wire loop, and said fifth wire loop does not intersect with said sixth wire loop.

13. The whisk assembly recited in claim 1, wherein said plurality of wire loops curve radially inward opposite said handle.

14. The whisk assembly recited in claim 1, wherein said at least one wire loop emanating from said first portion also ends within said first portion, said at least one wire loop emanating from said second portion also ends within said second portion, and said at least one wire loop emanating from said third portion also ends within said third portion.

15. The whisk assembly recited in claim 1, wherein said first, second, and third portions of said handle are formed as a single integral unit.

16. The whisk assembly recited in claim 1, wherein said first and second hinges are formed as a single integral unit with said first, second, and third portions of said handle.

17. A utensil, comprising:
a handle having a first end, a second end, a first portion, at least a second portion wherein said first portion is securable to said at least second portion along a surface arranged between said first end and said second end; and,
at least one element emanating from said first portion proximate said first end of said handle and at least one element emanating from said second portion proximate said first end of said handle;
wherein:
in a closed position, said first and second portions are operatively arranged to form a closed handle; and,
in an open position, said first and second portions are operatively arranged to form an open handle.

18. The utensil recited in claim 17, wherein said first portion is hingedly secured to said second portion by a first hinge.
